(19) United States
(12) Patent Application Publication
(10) Pub. No.: US 2023/0050189 A1
(43) Pub. Date: Feb. 16, 2023

(54) Electric Drive with a Parking Lock Device, and Axle Drive Assembly Comprising the Electric Drive for a Motor Vehicle

(71) Applicant: ZF FRIEDRICHSHAFEN AG, Friedrichshafen (DE)

(72) Inventor: Reinhard DEPPERT, Gochsheim (DE)

(21) Appl. No.: 17/793,714

(22) PCT Filed: Jan. 21, 2021
(86) PCT No.: PCT/EP2021/051269

§ 371 Date: Jul. 19, 2022

(30) Foreign Application Priority Data
Jan. 23, 2020 (DE) 10 2020 200 770.5

(51) Int. Cl. F16H 63/34; B60K 17/16; B60K 1/00

(52) U.S. Cl. CPC F16H 63/3425; B60K 17/165; B60K 1/00; B60K 2001/001

(57) ABSTRACT

An electric drive for a motor vehicle includes: a drive housing with a motor housing section and a motor chamber. A stator and a rotor, the rotor being rotatably mounted relative to the stator by a rotor shaft, are arranged in the motor chamber. The electric drive also includes a parking lock with an engagement mechanism configured to lock the rotor shaft relative to the drive housing is arranged in the electric drive.

### CROSS REFERENCE TO RELATED APPLICATIONS

This is a U.S. national stage of International application No. PCT/EP2021/051269, filed on Jan. 21, 2021, which claims priority to German Application No. 10 2020 200 770.5 filed Jan. 23, 2020, the content of each of which is incorporated herein by reference.

### BACKGROUND OF THE INVENTION

### 1. Field of the Invention

The invention relates to an electric drive for driving a motor vehicle and to an axle drive arrangement having the electric drive.

### 2. Related Art

An axle drive arrangement for a vehicle has become known from DE 10 2005 022 926 B3, which vehicle comprises an electric drive, which is designed as an electric machine, a change speed gear and a differential gear, which is connected to wheel drive shafts. These components are accommodated in a common housing, wherein a motor compartment is provided to accommodate the electric machine and a gear compartment, which is separate from said motor compartment, is provided to accommodate the gear. When flange-mounting the electric machine on a partition wall of the housing, the rotor shaft is brought into rotationally fixed communication with the input shaft of the change speed gear. A parking lock is designed for parking a vehicle equipped with such an axle drive arrangement, which parking lock is arranged together with an engagement mechanism and an actuating device inside the gear compartment. In this case, the engagement mechanism acts on the gear input shaft, which is connected to the rotor shaft.

Parking lock devices, also referred to simply as parking locks, are moreover generally known from vehicles having hydrodynamic torque converters and serve to secure the vehicle against unintentionally rolling away when the motor is switched off, wherein it is common practice to block the gear output shaft, which is connected to the drive wheels in a rotationally fixed manner. To this end, a ratchet wheel can be arranged for example on the gear output shaft in a rotationally fixed manner, which ratchet wheel can be influenced by a pawl as stipulated by the driver. Such a parking lock has become known by way of example from DE 195 35 239 C1.

### SUMMARY OF THE INVENTION

An object of the present invention is to provide an electric drive and an axle drive arrangement having an electric drive for a motor vehicle, in which a parking lock device for parking the motor vehicle is arranged in an optimized manner in terms of function, assembly and also maintenance.

The above-mentioned objects may be achieved by an electric drive.

for a motor vehicle, which comprises a drive housing having a motor housing portion and having a motor compartment formed in said motor housing portion. A stator and a rotor, which is mounted such that it is rotatable with respect to the stator, are arranged in the motor compartment and together form an electric machine.

According to an aspect of the present invention, it is provided that the electric drive has a parking lock device (also referred to as a “parking lock”) having an engagement mechanism for locking the rotor shaft relative to the drive housing.

In other words, the parking lock device is now configured as a component of the electric drive and, together with the electric machine of the drive, forms a prefabricated module which can be inserted or added into a vehicle drive train as required and joined to further drive train components there. The integration of the parking lock device in the drive enables a greater degree of design freedom in the configuration of gear arrangements located in the drive train, so that they can therefore be configured in a more space saving manner. Moreover, as a result of associating the parking lock device with the drive, a comparatively long torque transmission section between the driven vehicle wheels and the parking lock device can be realized and the elasticity of the drive train can be exploited in an optimum and comfort-enhancing manner during the engagement of the parking lock. In the event of a defect or intended maintenance, the drive can be released from its assembly position, whereby the elements of the parking lock device are accessible.

The parking lock device can advantageously have an actuating device for activating the engagement mechanism, which actuating device is fixed to the drive housing. The actuating device can therefore be configured to be spatially adjacent to the engagement mechanism and it can be arranged inside or outside the drive housing and supported there.

In the proposed electric drive, the drive housing can further advantageously have a parking lock housing portion having a parking lock compartment, with at least the engagement mechanism of the parking lock device being accommodated in the parking lock compartment. To form the parking lock compartment and the motor compartment, the drive housing can be configured in one part or in multiple parts, in particular in two parts. In another respect, it may be expedient to configure the parking lock compartment such that it is separate from the motor compartment. To this end, the motor compartment can be configured, for example, as a wet compartment for cooling the electric machine, whereas the parking lock compartment can be configured as a dry compartment which is separate from the wet compartment.

In the electric drive, the actuating device can preferably be configured for electromechanical actuation and comprise an actuating drive as an actuator, which actuating drive is arranged inside the drive housing in a particularly space saving manner.

According to one embodiment, the engagement mechanism can have a parking lock wheel, which is arranged on the rotor shaft and has latching teeth, and a pawl, which is fixed to the drive housing, cooperates with the latching teeth and can be controlled by the actuating device. diameter of an electric machine of the vehicle drive is conventionally greater than a parking lock wheel commonly used in practice, so a parking lock device which is constructed in this way can be arranged in the vicinity of the rotor and stator of the electric machine without design issues.

For connection to a housing of a further drive train component of a vehicle, the drive housing can have an assembly flange, which can be advantageously provided on the parking lock housing portion. To this end, an end-face flange can be provided there, through which the rotor shaft or a drive shaft, which is connected to said rotor shaft, can be guided.

According to a further aspect of the invention, an axle drive arrangement for a motor vehicle is proposed, which axle drive arrangement comprises an electric drive as explained above. the axle drive arrangement, the housing of the above-mentioned further drive train component is configured as a gear housing of a gear arrangement and connected to the drive housing, in particular to the parking lock housing portion. In this case, the gear arrangement comprises a gear input shaft, which is operatively connected to the rotor shaft, and at least one gear output shaft, which is connected to vehicle wheels to transmit a drive torque from the drive.

It is thus possible to use a module in the form of the electric drive having an electric motor and parking lock device universally and to combine it with gear arrangements of different designs to form a drive-gear module depending on the desired purpose. The drive explained above therefore forms a nonvariable part which can be used for a variety of drive train tasks. Since the parking lock device is already integrated therein, a gear arrangement which is to be combined with the drive can be configured in a functionally and spatially optimum manner, without the constraint of integrating the parking lock.

In particular, the gear arrangement can comprise a fixed or switchable reduction gear and/or an axle differential gear. The gear output shaft can furthermore be configured as a wheel drive shaft. A complete drive train can therefore be provided for an electric vehicle by the axle drive arrangement proposed here.

### BRIEF DESCRIPTION OF THE DRAWINGS

The invention will be explained by way of example below, with reference to an embodiment which is illustrated in the figures, in which:

FIG. 1 shows an axle drive arrangement for a motor vehicle having an electric drive and having a gear arrangement;

FIG. 2 shows an axial sectional illustration of the electric drive of FIG. 1, with a parking lock device; and

FIG. 3 shows an end-face view of the electric drive of FIG. 2, looking onto the parking lock device.

### DETAILED DESCRIPTION OF THE PRESENTLY PREFERRED EMBODIMENTS

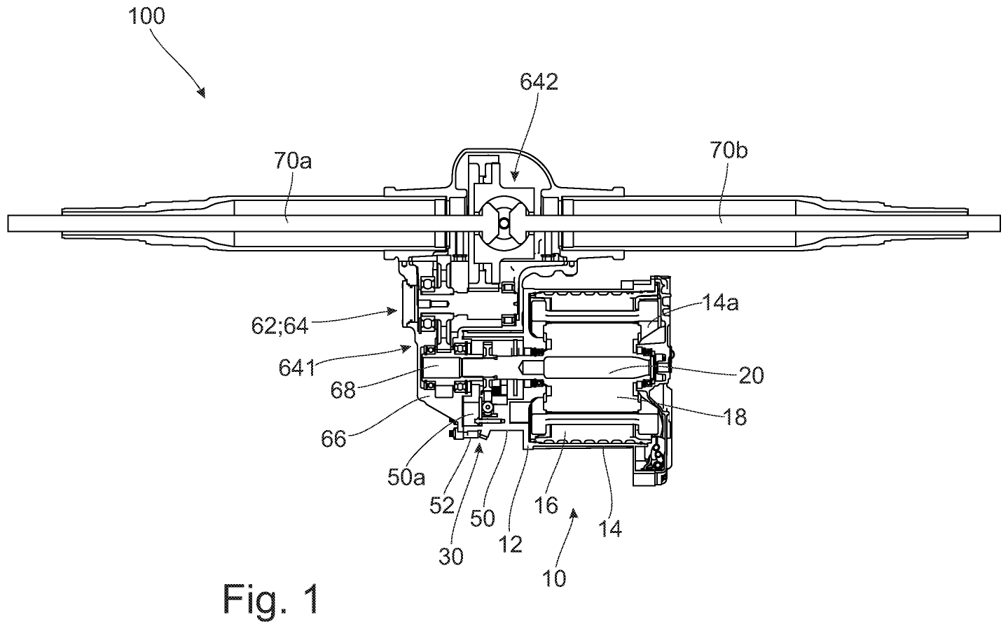

FIG. 1 shows an axle drive arrangement 100 for an electrically driven motor vehicle, which axle drive arrangement comprises an electric drive 10 and a gear arrangement 64 which is connected to said electric drive, whereby a drive torque can be transmitted to vehicle wheels (not represented graphically).

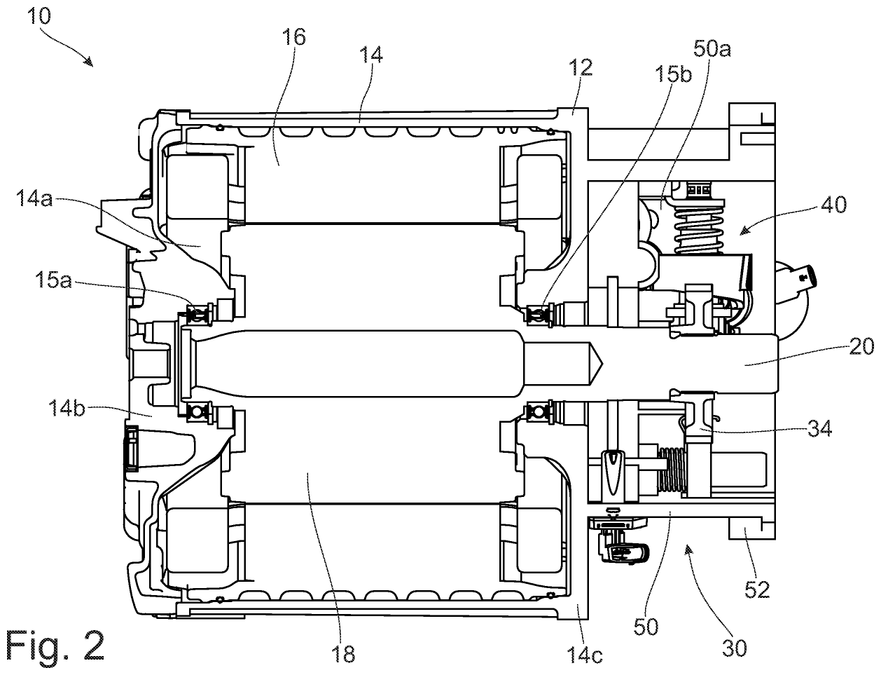

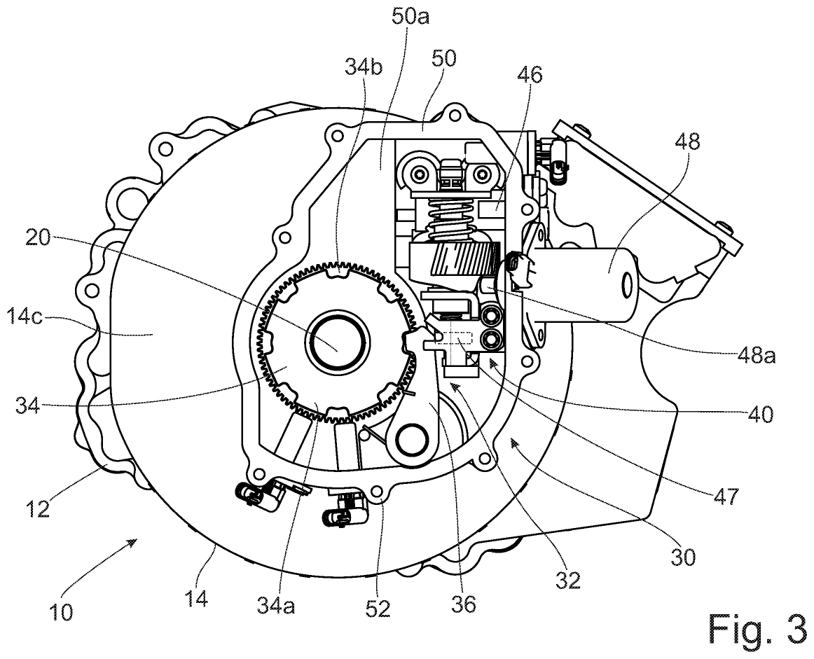

The electric drive 10 shown in FIGS. 2 and 3 is configured as an internal electric machine and has a drive housing 12, which forms a motor housing portion 14 with a motor compartment 14a. A stator 16 and a rotor 18 are arranged in the motor compartment 14a in a conventional manner. To this end, the stator 16 is fixed to the motor housing portion 14 and the rotor 18 is mounted by a rotor shaft 20 and by bearings 15a, 15b, which are located on end shields 14b, c, such that it is rotatable with respect to the stator 16.

The electric drive 10 further has a parking lock device 30, whereby the vehicle wheels and the torque-transmitting components of the drive train which are in operative communication with said drive wheels can be blocked. In the present case, the parking lock device 30 has an engagement mechanism 32 for locking the rotor shaft 20 relative to the drive housing 12. The engagement mechanism 32 comprises a parking lock wheel 34, which is arranged on the rotor shaft 20 in a rotationally fixed manner and has latching teeth 34a, and a pawl 36, which is pivotably fixed on the drive housing 12, cooperates with the latching teeth and can be controlled or activated by an actuating device 40, which is likewise fixed to the drive housing 12. The actuating device 40 is configured for electromechanical actuation and, to this end, comprises an actuating drive 46, which is arranged inside the drive housing 12, or a parking lock actuator 46, which, via a mechanical transmission chain having a reduction gear, a screw drive and a rotating ramp, converts a rotational movement of the actuating drive 46 into a translatory movement of a detent 47, which is mostly covered in FIG. 3 and is therefore partially illustrated by a dashed line. As a result, the pawl 36 is brought into engagement with a tooth gap 34b of the latching teeth 34a of the parking lock wheel 34 as a result of an axial displacement of the detent 48. For emergency actuation of the parking lock device 30, an electromagnetic emergency unlocking actuator 38 is provided on the outside of the parking lock housing portion 50, which emergency unlocking actuator engages in the parking lock compartment 50a by a tension rod 48a and brings about an unlocking of the parking lock device 30 upon its actuation.

As can be seen in the figures, the drive housing 12 has a parking lock housing portion 50, which is configured in one part with the motor housing portion 14 here and has a parking lock compartment 50a in which the above-mentioned engagement mechanism 32 and elements of the actuating device 21 are accommodated. In the exemplary embodiment addressed here, the parking lock compartment 50a is configured to be separate from the motor compartment 14a, although this is not compulsory. The elements of the electric machine, i.e. the stator 16 and the rotor 18, can alternatively also be located in a common compartment, at least with the elements of the engagement mechanism 32 and furthermore possibly with the elements of the actuating device 40.

As can furthermore be seen in FIGS. 1-3, the parking lock housing portion 50 has an assembly flange 52 for producing a connection, in particular a screw connection, to the gear housing 66 of the gear arrangement 64, which assembly flange which is formed around the rotor shaft 52. The gear arrangement 64 furthermore comprises a gear input shaft 68, which is connected to the rotor shaft 20 in a rotationally fixed manner in the region of the partition point of the two housings or housing portions 50, 66. In the exemplary embodiment addressed here, the gear arrangement 64 has a reduction gear 641 and a subsequent axle differential gear 642 having two gear output shafts 70a, b configured as wheel drive shafts. The gear output shafts 70a, 7-b are operatively connected to vehicle wheels in order to transmit a drive torque originating from the drive 10.

Although exemplary embodiments have been discussed in the above description, it should be noted that numerous modifications are possible. Furthermore, it should be noted that the exemplary embodiments are merely examples which are not intended to limit the scope of protection, the applications and the structure in any way. Rather, a person skilled in the art will take from the above description a guideline for implementation of at least one exemplary embodiment, wherein various modifications may be made, in particular with regard to the function and arrangement of the described components, without departing from the scope of protection as can be gathered from the claims and equivalent feature combinations

### REFERENCE SIGNS

10 Electric drive
12 Drive housing
14 Motor housing portion
14a Motor compartment
14b, c End shield
15a, b Bearing
16 Stator
18 Rotor
20 Rotor shaft
30 Parking lock device
32 Engagement mechanism
34 Parking lock wheel
34a Latching teeth
34b Tooth gap
36 Pawl
40 Actuating device
46 Actuating drive
47 Detent
48 Emergency unlocking actuator
48a Tension rod
50 Parking lock housing portion
50a Parking lock compartment
52 Assembly flange
62 Drive train components
64 Gear arrangement
641 Reduction gear
642 Axle differential gear
66 Gear housing
68 Gear input shaft
70a, b Gear output shaft
100 Axle drive arrangement

1-10. (canceled)

11. An electric drive (10) for a motor vehicle, comprising:
a drive housing (12) having a motor housing portion (14), which defines a motor compartment (14a);
a stator (16), arranged in the motor compartment (14a); and
a rotor (18), wherein
the rotor (18) is mounted by a rotor shaft (20) so as to be rotatable with respect to the stator (16), wherein
the electric drive (10) has a parking lock (30) having an engagement mechanism (32) for locking the rotor shaft (20) relative to the drive housing (12).

12. The electric drive as claimed in claim 11, wherein the parking lock (30) has an actuating device (32) for activating the engagement mechanism (32), which actuating device is fixed to the drive housing (12).

13. The electric drive as claimed in claim 12, wherein the drive housing (12) has a parking lock housing portion (50) having a parking lock compartment (50a), wherein the engagement mechanism (32) of the parking lock (30) is accommodated in the parking lock compartment (50a).

14. The electric drive as claimed in claim 13, wherein the parking lock compartment (50a) is configured to be separate from the motor compartment (14a).

15. The electric drive as claimed in claim 14, wherein the actuating device (40) is configured to provide electromechanical actuation and comprises an actuating drive (46), which is arranged inside the drive housing (12).

16. The electric drive as claimed in claim 15, wherein the engagement mechanism (32) has a parking lock wheel (34), which is arranged on the rotor shaft (20) and has latching teeth (34a), and a pawl (36), which is fixed to the drive housing (12), cooperates with said latching teeth and is controllable by the actuating device (40).

17. The electric drive as claimed in claim 16, wherein the parking lock housing portion (50) has an assembly flange for connection to a housing (66) of a drive train component (62) of a vehicle.

18. An axle drive arrangement (100) for a motor vehicle, comprising an electric drive (10) as claimed in claim 17, wherein the housing (66) is configured as a gear housing of a gear arrangement (64) and is connected to the parking lock housing portion (50) of the drive housing (12), and wherein the gear arrangement (64) comprises a gear input shaft (68), which is operatively connected to the rotor shaft (20), and at least one gear output shaft (70a, 70b), which is operatively connected to vehicle wheels so as to transmit a drive torque from the drive (10).

19. The axle drive arrangement (100) as claimed in claim 18, wherein the gear arrangement (64) comprises a reduction gear (641) and/or an axle differential gear (642).

20. The axle drive arrangement (100) as claimed in claim 18, wherein the gear output shaft (70a, b) is configured as a wheel drive shaft.
